(19) United States
(12) Patent Application Publication
(10) Pub. No.: US 2019/0353510 A1
(43) Pub. Date: Nov. 21, 2019

(54) ELECTRONICS UNIT FOR A FLOW METER

(71) Applicant: AVL LIST GMBH, GRAZ (AT)

(72) Inventors: OTFRIED DERSCHMIDT, GRAZ (AT); MANFRED PROSS, GRAZ (AT); HERIBERT KAMMERSTETTER, SALZBURG (AT)

(73) Assignee: AVL LIST GMBH, GRAZ (AT)

(21) Appl. No.: 16/071,076

(22) PCT Filed: Jan. 20, 2017
(86) PCT No.: PCT/EP2017/051175

§ 371 Date: Jul. 19, 2018

(30) Foreign Application Priority Data
Jan. 21, 2016 (AT) A 22-2016

(51) Int. Cl. G01F 15/14

(52) U.S. Cl. CPC G01F 15/14

(57) ABSTRACT

An electronics unit for a flow meter which includes a housing. The electronics unit includes a motherboard which controls the flow meter, at least one additional circuit board with additional electronic components, an electric plug connection arranged between the motherboard and the at least one additional circuit board, a connection box in which the at least one additional circuit board is fastened, and an electrical plug connection which connects the at least one additional circuit board to the motherboard in an electrically detachable manner. The motherboard is secured in the housing of the flow meter. The connection box is mechanically secured to the housing of the flow meter in a detachable manner.

### CROSS REFERENCE TO PRIOR APPLICATIONS

This application is a U.S. National Phase application under 35 U.S.C. § 371 of International Application No. PCT/EP2017/051175, filed on Jan. 20, 2017 and which claims benefit to Austrian Patent Application No. A 22-2016, filed on Jan. 21, 2016. The International Application was published in German on Jul. 27, 2017 as WO 2017/125542 A1 under PCT Article 21(2).

### FIELD

The present invention relates to an electronics unit for a flow meter, the electronics unit comprising a motherboard for controlling the flow meter, at least one further additional circuit board which has additional electronic components, an electrical connection between the motherboard and the at least one additional circuit board, and a connection box in which the at least one additional circuit board is secured.

### BACKGROUND

Such electronics units are used in various devices, for example, for driving the electronics, which driving is normally performed via the motherboard, for receiving electronical feedback, which may be effected via measured-value detection cards, for forwarding or processing data, or for communicating with other electronics units via radio modules.

Known flow meters are used, for example, for determining injected fluid amounts of injection valves at internal combustion engines. These flow rate meters comprise an electric-motor-operated displacement meter in the form of a gear pump which is arranged in parallel to a differential pressure transducer in the form of a piston arranged in a piston chamber, wherein the gear pump is driven so that the differential pressure is compensated for at the differential pressure transducer, i.e., no differential pressure is produced across the piston.

It is necessary for this purpose to accordingly drive the drive and control unit of the gear pump. The control unit is composed of an electric drive unit as well as an associated motherboard via which the signals of the electric motor can be received, for example, the power supply of the stator can be performed according to the required driving signals or the processing of the data of the flow meter can be performed. Depending on the application, different data must accordingly be transmitted to the motherboard or processed therein, wherein, in this case, further circuit boards must be connected to the flow meter to provide a correct data exchange, which, however, are differently configured depending on the configuration of the flow meter. These electronics units are accordingly in most cases installed at different places in the flow meter by securing the various additional circuit boards at housing portions of the flow meter via screws, for example. Via additional cables to be laid in the housing, the additional circuit boards are subsequently connected with each other if required. The respective plugs of the additional circuit boards also project from the housing at various positions.

It must be taken into consideration, however, that all connectors of such flow meters extending outwards must conform with the explosion protection standard of the European Union. During calibration, each connector must consequently first be individually disconnected and subsequently reconnected according to the standard. The flow meters are therefore frequently sold in many different versions where different additional circuit boards are respectively permanently installed in the interior of the housing. This results in a considerably increased logistic effort and increasing manufacturing and installation costs.

### SUMMARY

An aspect of the present invention is to provide an electronics unit for a flow rate meter where decoupling and reconnection of additional circuit boards are facilitated and where a standard design of a flow meter can be provided which can simply be extended by additional functions if desired absent an excessive additional installation or manufacturing effort while still complying with the explosion protection standard.

In an embodiment, the present invention provides an electronics unit for a flow meter which comprises a housing. The electronics unit includes a motherboard configured to control the flow meter, at least one additional circuit board comprising additional electronic components, an electric plug connection arranged between the motherboard and the at least one additional circuit board, a connection box in which the at least one additional circuit board is fastened, and an electrical plug connection configured to connect the at least one additional circuit board to the motherboard in an electrically detachable manner. The motherboard is secured in the housing of the flow meter. The connection box is mechanically secured to the housing of the flow meter in a detachable manner.

### BRIEF DESCRIPTION OF THE DRAWINGS

The present invention is described in greater detail below on the basis of embodiments and of the drawings in which:

FIG. 1 shows a perspective view of a flow meter with a mounted connection box;

FIG. 2 shows a corresponding view of the electronics unit immediately before installation of the connection box to the flow meter, wherein the housing of the flow meter is partly shown in a cross-sectional view;

FIG. 3 shows a perspective view of the connection box from an open side;

FIG. 4 shows a perspective view of the connection box from a side opposite to that of FIG. 3, with the cover being opened;

FIG. 5 shows a perspective view of the arrangement of the additional circuit board of the electronics unit with the connection box being cut away; and

FIG. 6 shows a perspective view of the connection box from a side opposite to that of FIG. 3, with the cover being opened and having an alternative type of securing.

### DETAILED DESCRIPTION

Due to the fact that the at least one additional circuit board is connected in an electrically detachable manner to the motherboard via an electrical plug connection, the motherboard being secured in a housing of the flow meter, and the connection box is mechanically and detachably secured to the housing of the flow meter, merely a plug connection must be detached from the flow meter for electrically connecting and detaching the additional circuit boards. This considerably reduces the installation effort in particular since a defined position of the connection box to the housing of the flow meter is determined, whereby the mechanical and electrical connections have a long life period. The flow meter can also be customized by different equipment with additional circuit boards in the connection box without any change to the flow meter and without having to establish any additional connections. The explosion protection standard is easy to comply with in such an electronics unit.

In an embodiment of the present invention, a plurality of additional circuit boards can, for example, be arranged in the connection box, the plurality of additional circuit boards being aligned to each other via slot-and-key connections. The position of the additional circuit boards in the connection box with respect to each other is accordingly realized by a form fit so that additional installation steps for securing purposes or additional securing devices are omitted.

In an embodiment of the present invention, the connection box can, for example, have an open side from which the plug for establishing the electrical plug connection to the motherboard projects and through which the additional circuit boards are adapted to be inserted into the connection box. A box closed on five sides can thus be used which can accordingly be tightly sealed and need not be assembled. The closure of the open side can be effected by securing the connection box to the housing and simultaneously establishing an electrical connection to the motherboard so as to create a connection box closed on all sides.

In this embodiment, the plug can, for example, be a flat plug of a bus system. Its number of connections to be allocated can be simply changed by a corresponding configuration of the additional circuit boards used, wherein the connection to the motherboard is to be established via a simple pushing thereon.

For electrically connecting the connection box and, together with the connection box, the motherboard and the flow meter to a central voltage source or additional central control or evaluation units, at least one electric connection plug or a cable bushing can, for example, be secured to a first additional circuit board inside the connection box and project(s) to the outside from the interior of the connection box through an opening in a side wall of the connection box. These plugs or bushings continue to be easily accessible even after securing the connection box and can be configured as explosion-proof components.

It is particularly advantageous when the additional circuit board comprising the connection plugs is positioned by securing the connection plug to the side wall of the connection box inside the connection box. This is effected, for example, in that the connection plug comprises a thread at its outer circumference onto which a nut is screwed after the connection plug has been inserted through the opening of the side wall. An individual securing of the additional circuit board and the connection plug is accordingly not required.

In an embodiment of the present invention, two additional circuit boards with connection plugs can, for example, be arranged inside the connection box whose connection plugs project through openings of the connection box at opposite side walls so that the additional circuit boards are arranged at opposite sides of the connection box. This reduces the required installation space of the connection box.

In an embodiment of the present invention, one of the walls of the connection box can, for example, be covered by a plastic cover which can be of a hinged type or screwed on. Between the wall and the plastic cover, an additional circuit board of a radio module can thus be arranged which, accordingly, is not shielded like the interior of the connection box without a cover. The plastic cover accordingly offers the possibility of a radio transmission device which is reliably protected against contamination and, together with the connection box, can be mounted to the housing of the flow meter.

The additional circuit board of the radio module is arranged at a rear wall disposed opposite to the open side and between the rear wall of the connection box and the hinged plastic cover for this purpose. The radio module remains fully accessible in such a configuration.

In an embodiment of the present invention, two additional circuit boards inside the connection box can, for example, be electrically connected with each other via a flat cable. Electrical contacting of two additional circuit boards can thus be established in a simple manner.

In an embodiment of the present invention, a third additional circuit board can, for example, be aligned via the slot-and-key connections with the two additional circuit boards which comprise the connection plugs. An easy-to-produce slot-and-key connection accordingly completely defines the position of the third additional circuit board in the connection box without having to use any securing device. An electrical connection between the additional circuit boards can also be established in a simple manner, for example, by soldering.

In an embodiment of the present invention, a tongue of the third additional circuit board formed at its end can, for example, project from the connection box through a slit in the rear wall on the side opposite to the plug and can, for example, be secured to the rear wall by a retaining element in a form-fit manner. A two-sided securing of the first and the second additional circuit board via the third additional circuit board arranged vertically to the former is thus produced, whereby a high insensitivity to shocks is achieved. Any relative displacement of the additional circuit boards with respect to each other is prevented.

In an embodiment of the present invention, the retaining element can, for example, be a fixing plate having two noses, wherein the fixing plate rests against the rear wall and the noses engage behind two laterally protruding hooks at the end of the tongue of the third additional circuit board. The noses of the fixing plate can accordingly be simply pushed along the rear wall and under the hooks, whereby a form-fit is produced which prevents the third additional circuit board from being displaced.

In an embodiment of the present invention, the retaining element can, for example, be the additional circuit board of the radio module comprising two projections which engage behind two laterally protruding hooks at the end of the tongue of the third additional circuit board. Additional components may thus be omitted and the two cards have a form-fit retainer.

The height of the third additional circuit board can, for example, essentially correspond to the distance between a bottom and a top of the connection box so that the third additional circuit board is clamped between the bottom and the top of the connection box to prevent a movement in the box.

The third additional circuit board is advantageously an SD-card circuit board which, when designed accordingly, can be read from outside when the corresponding contacts are formed at the portion of the SD-card projecting through the rear wall.

A simple electrical connection between the additional circuit boards can be established by connecting at least two assembled additional circuit boards by soldering.

An electronics unit for a flow meter is thus provided which offers a high flexibility of the flow meter according to the customer's requirements with minimum installation effort. Only one connection between the flow meter must be calibrated and additional electronic components additionally exists, whereby detaching of the connections and restoring of the connections can be carried out with minimal effort. The installation space for an additional electronics is minimized. The electronics is also shielded, protected against contamination, and accommodated in a vibration-proof manner.

The electronics unit for a flow meter according to the present invention is described below on the basis of an exemplary embodiment which is illustrated in the drawings and which is not intended to be understood as limiting.

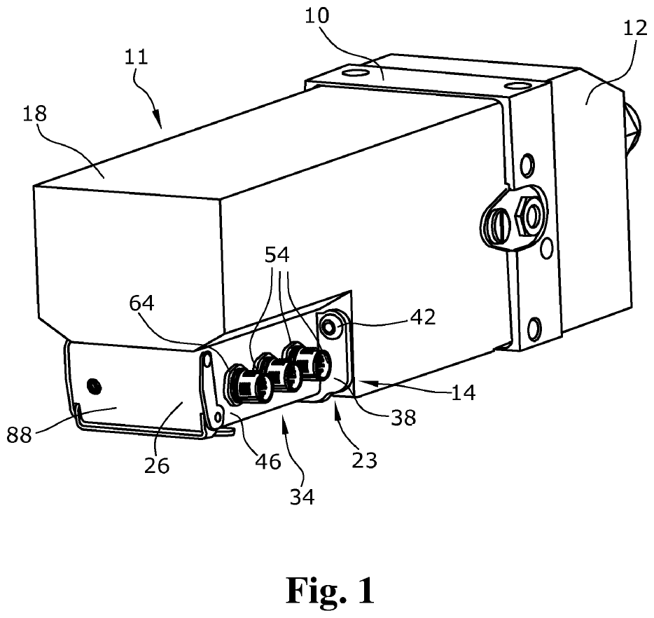

The flow meter 11 shown in FIG. 1 is provided as an electric-motor-driven displacement meter 11 in the form of a gear pump, which is arranged in a housing 10 and is fluidically arranged in parallel to a differential pressure transducer in the form of a piston arranged in a piston chamber, whose housing is protected by a covering 12. The gear pump is driven so that the differential pressure at the differential pressure transducer is compensated for, i.e., no differential pressure is produced across the piston. For performing such a control, the drive motor of the gear pump must be properly driven and different measured values must be acquired, further processed and returned. A flow must also be calculated from the captured measured and control values and these data must be transmitted to external devices.

For this purpose, an electronics unit 14 according to the present invention is used which comprises a motherboard 16 that, together with the drive motor, is arranged inside a cover hood 18 of the housing 10 and via which the drive motor is driven depending on the measured values.

The motherboard 16 is secured to carrier elements 19 and comprises a mating plug 20 of a BUS-system at its end facing away from the housing 10. Into this mating plug 20, a plug 22 for establishing an electrical plug connection 23 can be inserted which projects from an open side 24 of a connection box 26 and is formed by contact ends 28 of two additional circuit boards 30, 32 arranged inside the connection box 26.

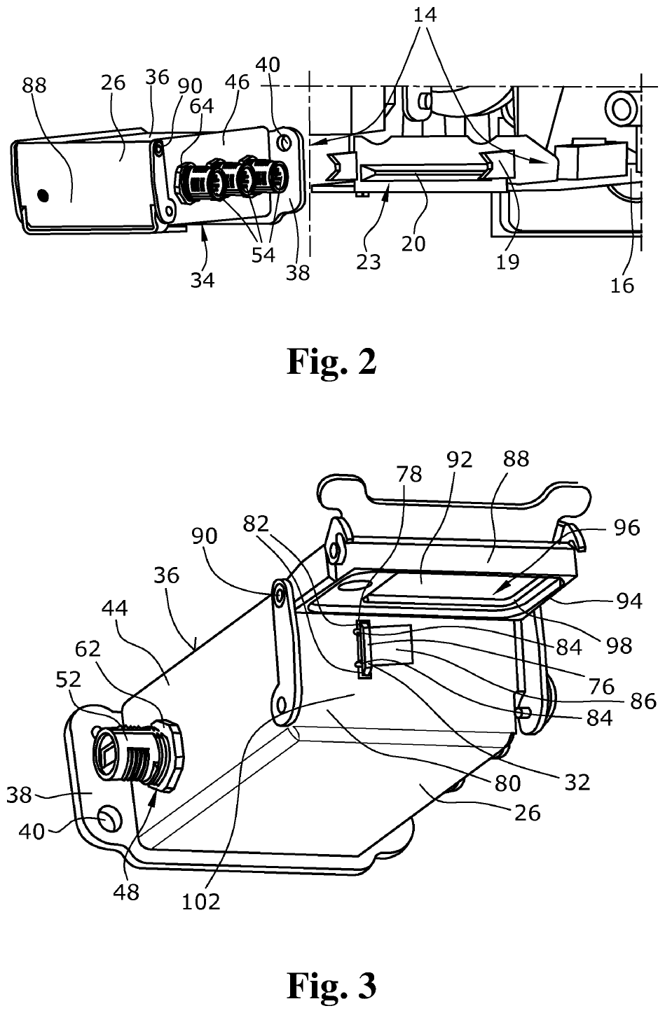

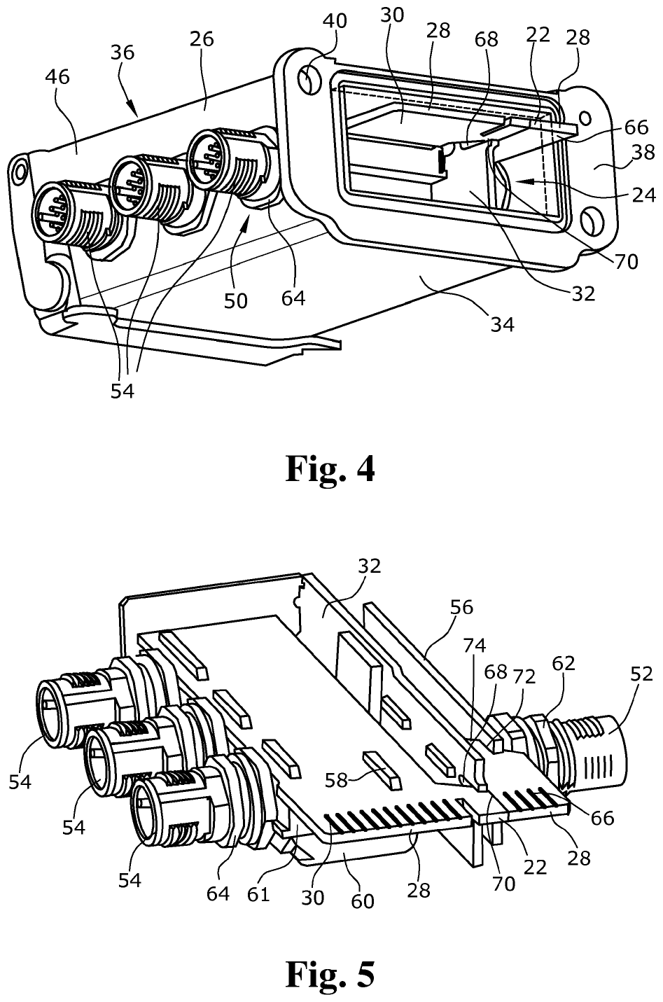

FIG. 3 will hereafter be used for explanation purposes to facilitate understanding of the present invention. The following terms, such as “left”, “right”, “side wall”, “cover” and “bottom”, “horizontal” and “vertical”, are thus not intended to be understood in a limiting sense with regard to the actual installation position. The connection box 26 is essentially configured as a rectangular block and comprises a closed bottom 34 as well as a closed top 36 facing the cover hood 18. On its open side 24, the connection box 26 comprises a flange-type enlarged portion 38 with bores 40 via which the connection box 26 can be mechanically secured to the cover hood 18 or one of the carrier elements 19 via screws 42. In opposite side walls 44, 46 openings 48, 50 are formed through which electric connection plugs 52, 54 project to the outside from the interior of the connection box 26.

In the present exemplary embodiment, a total of three additional circuit boards 30, 32, 56 are arranged inside the connection box 26 which carry additional electronic components 58 that are not provided on the motherboard 16 so that, according to the customer's requirements, the number and configuration of the additional circuit boards 30, 32, 56 and their electronic components 58 can be changed without any further modifications to the flow meter 11 having to be carried out.

Fixing and installing of the additional circuit boards 30, 32, 56 inside the connection box 26 according to the present invention are carried out by first pushing the first additional circuit board 56 into the connection box 26 from the open side 24. This first additional circuit board 56 comprises a flat cable 60 and the connection plug 52 which is pushed through the opening 48 in the side wall 44 from inside. The position of the additional circuit board 56 at the side wall 44 is fixed by screwing a nut 62 onto the connecting plug 52 from outside.

The second additional circuit board 30 is then pushed into the connection box 26 from the open side 24. This second additional circuit board 30 comprises a total of three connection plugs 54 which are pushed through three correspondingly shaped openings 50 in the side wall 46 opposite to the side wall 44. The first additional circuit board 56 extends along the side wall 44, while the second additional circuit board extends in parallel to the closed bottom 34 after having been secured by nuts 64 which are screwed onto the connection plugs 54 from outside. At its end projecting from the open side 24, a left portion of the contact ends 28 of the plug 22, as seen from the open side 24, is formed. The flat cable 60 of the first additional circuit board 56 is then inserted into a plug element 61 of the second circuit board 30.

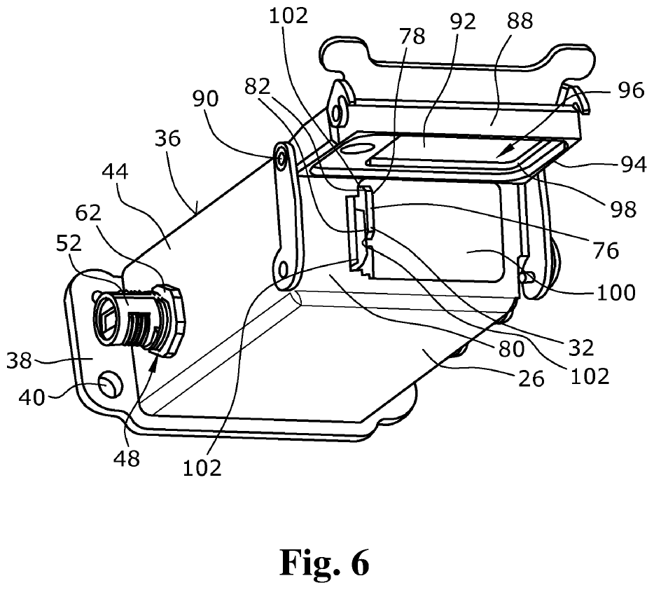

In the present exemplary embodiment, the third additional circuit board 32 is an SD-card circuit board whose height corresponds to the distance from the closed bottom 34 to the closed top 36 of the connection box 26. In the installed state, it extends vertically from the closed bottom 34 to the closed top 36 of the connection box 26 and comprises a bent end 66 where the right portion of the contact ends 28 of the plug 22 is formed and which accordingly extends horizontally in the connection box 26 as an extension of the end of the second additional circuit board 30 projecting from the open side 24. For installation purposes, this third additional circuit board 32 is inserted into the connection box 26, wherein at the end of the additional circuit board 32 facing the open side in its vertically extending area, a slot 68 is formed which is pushed over an enlarged portion of the second additional circuit board 30 acting as a key 70. At the first additional circuit board 56, a slot 72 is additionally formed into which an enlarged portion of the third additional circuit board 32 acting as a key 74 and formed in the horizontally extending area engages when the third additional circuit board 32 is inserted. At the rear end, the third additional circuit board 32 comprises a tongue 76 which is pushed through a slit 78 during insertion into the connection box, which slot is formed in a rear wall 80 opposite to the open side as shown in FIGS. 3 and 6. In this state, the third additional circuit board 32 is accordingly secured at three places in a form-fit manner. For preventing the third additional circuit board 32 from moving against the insertion direction, the tongue 76 is provided with two laterally protruding hooks 82 behind which engage two noses 84 of a retaining element configured as a fixing plate 86 which is pushed along the rear wall 80 so that the noses 84 are clamped between the rear wall 80 and the hooks 82. The position of all three additional circuit boards 30, 32, 56 is thus fully defined. The second additional circuit board 30 is also soldered to the third additional circuit board 32 in the area of the slot 68-key 70 connection.

A hinged plastic cover 88 is additionally formed at the rear wall 80 of the connection box 26 which is secured to the connection box 26 via hinges 90. The plastic cover 88 comprises a closing plate 92 and walls 94 which vertically extend on all sides from the ends of the closing plates 92 towards the rear wall 80 so that, in the closed state, a small space 96 is formed between the rear wall 80, the connection box 26, and the plastic cover 88. At the plastic cover 88 on its side facing the rear wall 80, a circumferential seal 98 is additionally formed so the small space 96 is tightly sealed when the plastic cover 88 is closed. As is shown FIG. 6, this small space 96 serves for accommodating an additional circuit board 100 of a radio module which would not be operative inside the metallic connection box. Such an additional circuit board 100 may either be glued to the rear wall and/or additionally serve as a retaining element for fixing the third additional circuit board 32 in that, at the end of the additional circuit board 100, corresponding protrusions 102 are formed which can be pushed under the hooks 82 of the third additional circuit board 32. Assembly of the connection box 26 is completed by subsequently closing the plastic cover 88 and, in this state, its open side can be pushed into the mating plug 20 and fixed to the cover hood 18.

An electronics unit is thus provided where, as is required, for example, during calibration, an existing motherboard can be easily separated from a connection box, the equipment of which can be customized. The connections of such an electronics unit correspond to the European standards concerning explosion protection. Arrangement and securing of required additional circuit boards inside the connection box can be carried out by simply assembling and connecting them in a form-fit manner without any additional securing devices.

It should be appreciated that the scope of protection of the present invention is not limited to the described exemplary embodiment. The arrangement of the additional circuit boards with respect to each other and the number of the required boards may in particular vary according to the customer's requirements. Further different designs are also conceivable.

What is claimed is:

1-18. (canceled)

19: An electronics unit for a flow meter which comprises a housing, the electronics unit comprising:
a motherboard configured to control the flow meter, the motherboard being secured in the housing of the flow meter;
at least one additional circuit board comprising additional electronic components;
an electric plug connection arranged between the motherboard and the at least one additional circuit board;
a connection box in which the at least one additional circuit board is fastened, the connection box being mechanically secured to the housing of the flow meter in a detachable manner; and
an electrical plug connection configured to connect the at least one additional circuit board to the motherboard in an electrically detachable manner.

20: The electronics unit as recited in claim 19, further comprising:
a plurality of additional circuit boards arranged in the connection box, the plurality of additional circuit boards being aligned with respect to each other via slot-and-key connections.

21: The electronics unit as recited in claim 20, wherein,
the connection box comprises an open side from which a plug projects towards the motherboard for establishing the electrical plug connection and through which the plurality of additional circuit boards are adapted to be inserted into the connection box.

22: The electronics unit as recited in claim 21, wherein the plug is a flat plug of a bus system.

23: The electronics unit as recited in claim 19, wherein,
the connection box comprises a side wall with an opening, and
the at least one additional circuit board comprises at least one electric connection plug or a cable bushing secured thereto inside the connection box, the at least one electric connection plug or the cable bushing being configured to project to an outside from an interior of the connection box through the opening in the side wall of the connection box.

24: The electronics unit as recited in claim 23, wherein,
the at least one additional circuit board comprises the connection plug and is arranged inside the connection box by securing the connection plug to the side wall of the connection box.

25: The electronics unit as recited in claim 19, wherein,
the connection box comprises an open side and oppositely arranged side walls each of which comprises an opening, and
the at least one additional circuit board includes two additional circuit boards arranged inside the connection box, each of the two additional circuit boards comprising a connection plug, a respective connection plug being configured to project through a respective opening of the connection box at one of the oppositely arranged side walls.

26: The electronics unit as recited in claim 25, wherein the two additional circuit boards are connected to each other via a soldering.

27: The electronics unit as recited in claim 25, further comprising:
a flat cable,
wherein,
the two additional circuit boards are electrically connected with each other inside the connection box via the flat cable.

28: The electronics unit as recited in claim 25, further comprising:
a third additional circuit board which is aligned via slot-and-key connections with respect to the two additional circuit boards.

29: The electronics unit as recited in claim 28, wherein,
the connection box further comprises at least one wall, and
the at least one wall of the connection box is covered by a plastic cover which is hinged or screwed-on.

30: The electronics unit as recited in claim 29, further comprising:
a circuit board of a radio module arranged between the at least one wall and the plastic cover.

31: The electronics unit as recited in claim 30, wherein,
the at least one wall is a rear wall,
the rear wall is arranged opposite to the open side, and
the circuit board of the radio module is arranged at the rear wall and between the rear wall of the connection box and the plastic cover.

32: The electronics unit as recited in claim 31, further comprising:
a plug arranged to project toward the motherboard through the open side of the connection box for establishing the electrical plug connection; and
a retaining element,
wherein,
the rear wall comprises a slit formed therein, and
the third additional circuit board comprises a tongue formed at an end which projects from the connection box through the slit in the rear wall on a side opposite to the plug and is secured in a form-fit manner to the rear wall via the retaining element.

33: The electronics unit as recited in claim 32, wherein,
the tongue of the third additional circuit board comprises an end on which two laterally protruding hooks are arranged,
the retaining element is a fixing plate comprising two noses,
the fixing plate rests against the rear wall, and
the two noses are configured to engage behind the two laterally protruding hooks at the end of the tongue of the third additional circuit board.

34: The electronics unit as recited in claim 32, wherein the retaining element is the circuit board of the radio module.

35: The electronics unit as recited in claim 28, wherein
the connection box comprises a bottom and a top with a distance therebetween, and
a height of the third additional circuit board substantially corresponds to the distance between the bottom and the top of the connection box.

36: The electronics unit as recited in claim 28, wherein the third additional circuit board is an SD-card circuit board.
